(19) United States
(12) Patent Application Publication
(10) Pub. No.: US 2026/0335175 A1
(43) Pub. Date: Oct. 29, 2026

(54) FOOT ACTUATION DEVICE INTEGRATED WITH THERAPEUTIC SYSTEM

(71) Applicants: Nicole Sebastino, Pittsfield, MA (US); Roger Blinn, Amston, CT (US)

(72) Inventors: Nicole Sebastino, Pittsfield, MA (US); Roger Blinn, Amston, CT (US)

(21) Appl. No.: 19/659,143

(22) Filed: Apr. 27, 2026

Related U.S. Application Data
(60) Provisional application No. 63/796,345, filed on Apr. 28, 2025.

(51) Int. Cl. A61H 9/00; A61H 1/02

(52) U.S. Cl. CPC A61H 9/0092; A61H 1/0266; A61H 2201/1238; A61H 2209/00

(57) ABSTRACT

A device and method for performing compression therapy is provided. The device includes a compression therapy device configured to couple with a user's leg. A body having a connection portion and a foot portion, the connection portion being configured to couple with the compression therapy device and the foot portion, the connection portion extending from the foot portion. An actuator is disposed on the foot portion and positioned to engage a portion of the user's foot adjacent the user's toes, the actuator configured to move between a first position and an expanded position. A motive source that is operably coupled to the actuator and the compression therapy device, the motive source configured to cause the actuator to move between the first position and the expanded position.

### CROSS-REFERENCE TO RELATED APPLICATIONS

The present application claims the benefit and priority to U.S. Provisional Application Ser. No. 63/796,345 entitled “COMPRESSION THERAPY INCORPORATING FOOT MANIPULATION DEVICE” dated Apr. 28, 2025, the contents of which are incorporated by reference herein.

### BACKGROUND

The present disclosure is directed to a device for preventing muscle or tendon deterioration, and in particular, to a device and method for automatically activating the muscles and tendons of the foot and lower leg.

Therapeutic devices for patients' legs, such as sequential compression devices (SCDs) or deep vein thrombosis (DVT) sleeves, are extensively deployed in clinical environments to enhance circulation in patients with limited mobility and to prevent blood clot formation. These devices operate by cyclically inflating and deflating air chambers that encircle the leg to stimulate venous return. However, these devices do not address the impairment of muscles and tendons in the ankle and foot.

Despite their widespread use, existing therapeutic devices are primarily passive and fail to mitigate the risk of muscle or tendon deterioration in the patient's foot or ankle due to prolonged immobility. Nurses often employ manual foot manipulation techniques to simulate dorsiflexion and plantarflexion, thereby activating the Achilles tendon and adjacent muscles.

While existing therapeutic solutions are suitable for their intended functions, there remains a need for improvement, particularly in providing a device capable of performing foot and ankle therapy with the features described herein.

### SUMMARY

One aspect of the disclosure provides a device for performing compression therapy. The device includes a compression therapy device configured to couple with a user's leg. The device further includes a body having a connection portion and a foot portion, the connection portion being configured to couple with the compression therapy device and the foot portion, the connection portion extending from the foot portion. An actuator is disposed on the foot portion and positioned to engage a portion of the user's foot adjacent to the user's toes, the actuator being configured to move between a first position and an expanded position. A motive source is operably coupled to the actuator and the compression therapy device, the motive source being configured to cause the actuator to move between the first position and the expanded position.

In addition to one or more of the features described herein, or as an alternative, further embodiments of the device may include the actuator being one of a pneumatic, hydraulic, electromechanical, shape-memory, magnetic, or mechanical actuator.

In addition to one or more of the features described herein, or as an alternative, further embodiments of the device may include the actuator being a pneumatic actuator and the motive source being a fluid pump.

In addition to one or more of the features described herein, or as an alternative, further embodiments of the device may include a conduit having a first end fluidly coupled to the actuator and a second end configured to receive pressurized fluid from the fluid pump.

In addition to one or more of the features described herein, or as an alternative, further embodiments of the device may include the actuator being one of a bellows, a bladder, a wedge-shaped inflatable member, or an expandable chamber.

In addition to one or more of the features described herein, or as an alternative, further embodiments of the device may include the second end of the conduit being configured to removably couple with a tubing connector of the compression therapy device.

In addition to one or more of the features described herein, or as an alternative, further embodiments of the device may include the actuator having a first end positioned adjacent to the user's heel and a second end adjacent to the user's toes, the second end expanding to a size that is larger than the first end when the actuator is in the expanded position.

In addition to one or more of the features described herein, or as an alternative, further embodiments of the device may include the actuator comprising a first actuator and a second actuator, the first actuator being positioned between the second actuator and the foot portion.

In addition to one or more of the features described herein, or as an alternative, further embodiments of the device may include the connection portion having at least one of a first fastening strap or a second fastening strap arranged on opposite sides of the foot portion adjacent to the user's heel.

In addition to one or more of the features described herein, or as an alternative, further embodiments of the device may include at least one first fastening strip disposed on the first fastening strap and a second fastening strip disposed on the second fastening strap.

In addition to one or more of the features described herein, or as an alternative, further embodiments of the device may include the first fastening strip and the second fastening strip being removably coupled to the compression therapy device.

In addition to one or more of the features described herein, or as an alternative, further embodiments of the device may include a tubing connector having at least one inlet and at least one outlet, at least one of the at least one outlets being fluidly coupled to the second end of the conduit. The device may further include a splitter member having an inlet and at least two outlets, at least one of the two outlets being fluidly coupled to the second end, and the other of the at least two outlets being configured to fluidly couple to the compression therapy device.

In addition to one or more of the features described herein, or as an alternative, further embodiments of the device may include the actuator being removably coupled to the body and the motive source.

In addition to one or more of the features described herein, or as an alternative, further embodiments of the device may include at least one of the body and the actuator being a single-use device.

In addition to one or more of the features described herein, or as an alternative, further embodiments of the device may include the motive source supplying pressurized fluid to the compression therapy device and the actuator simultaneously.

According to another aspect of the disclosure a method for performing therapy is provided. The method includes engaging a compression therapy device with a user's leg. The compression therapy device connecting with a motive source. An actuator engaging with a bottom of a user's foot, the actuator being in a fixed position relative to the user's lower leg; actuating the actuator with the motive source to cause the user's foot to rotate about an ankle joint from a first position to a second position. Causing the user's foot to rotate from the second position back to the first position.

In addition to one or more of the features described herein, or as an alternative, further embodiments of the method may include receiving pressurized fluid in a conduit. The actuator being pressurized with the pressurized fluid from the first position to the second position, the actuator being at least partially disposed adjacent the user's toes. A motion of the user's foot being caused to move from the first position to the second position in response to the actuator being actuated. The fluid is then evacuated from the actuator and causes the user's foot to move from the second position to the first position.

In addition to one or more of the features described herein, or as an alternative, further embodiments of the method may include repeating the steps of receiving pressurized fluid, inflating the actuator, causing motion of the user's foot and venting the fluid for a plurality of predetermined cycles. The causing of the motion of the user's foot then causes at least one of ankle dorsiflexion and plantarflexion of the user's foot.

In addition to one or more of the features described herein, or as an alternative, further embodiments of the method may include disposing of the actuator upon completion of the therapy or at a predetermined time.

According to still another aspect of the disclosure a system for performing therapy is provided. The system includes a pump configured to supply pressurized air or fluid. A compression therapy device is configured to be removably coupled to a user's leg, the compression therapy device having at least one chamber that is fluidly coupled to the pump, the therapeutic compression sleeve having at least one first fastening strip disposed on an outer surface. A fluid connector is coupled between the pump and the at least one chamber. A body having a connection portion is configured to couple with the at least one first fastening strip and a foot portion, the connection portion extending from the foot portion. An actuator is disposed on the foot portion and positioned to engage a portion of the user's foot adjacent the user's toes, the actuator configured to move between a first position and an expanded position. A motive source is operably coupled to the actuator and configured to cause the actuator to move between the first position and second position.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a system for providing therapy to a patient's foot;

FIG. 2A is a schematic illustration of a system for performing therapy on a patient's foot in accordance with an embodiment;

FIG. 2B is another schematic illustration of the system of FIG. 2A;

FIG. 2C is a schematic illustration of an SCD sleeve for use with the system of FIG. 2A;

FIG. 2D is a schematic illustration of a device for performing therapy on a user's foot in accordance with an embodiment;

FIG. 2E is a schematic illustration of a connector assembly for use with the system of FIG. 2A;

FIG. 2F is a schematic illustration of the expanding and contracting of an actuator in the device of FIG. 2D in operation;

FIG. 2G is a block diagram illustrating the operation of the system of FIG. 2A;

FIG. 3 is a schematic illustration of a device for performing therapy on a patient's foot according to another embodiment;

FIG. 4 is a schematic illustration of a device for performing therapy according to still another embodiment; and

FIG. 5 is a schematic illustration of a device for performing therapy on a patient's foot according to still another embodiment.

The detailed description explains embodiments of the disclosure, together with advantages and features, by way of example with reference to the drawings.

### DETAILED DESCRIPTION

Embodiments of the present disclosure provide for a system and device for performing therapy on a patient's foot to address or prevent issues with soft tissue structures, such as the Achilles tendon for example. In some embodiments, this system provides advantages in enhancing circulation and activation of the foot or ankle tendons. This type of therapy may be desirable in situations where a user is confined to a bed, for example. Some embodiments of the present disclosure provide for a system and device for performing therapy for a patient in a hospital bed. Further embodiments of the present disclosure provide a device that moves a user's foot to provide at least one of ankle dorsiflexion or plantarflexion. Embodiments of the present disclosure provide advantages through cyclical, periodic, or aperiodic movement of a user's foot to activate the Achilles tendon and adjacent muscles in the ankle and foot, thereby reducing the risk of tendon and/or muscle impairment.

It should be appreciated that embodiments herein describe the use of the system in cooperation with other compression therapeutic devices or methods, such as compression limb sleeves, intermittent pneumatic compression (IPC) devices, sequential compression devices (SCDs), or deep vein thrombosis (DVT) sleeves, for example. As used herein, the term “compression therapy device” refers to medical devices or systems configured to apply pressure to a user's limb, including but not limited to compression limb sleeves, IPC devices, DVT devices, or SCD devices. In some embodiments, the compression therapy device may include one or more chambers or elements that apply pressure to the user's leg, calf, or ankle. It should be appreciated that the terms compression therapy device, compression limb sleeve, IPC device, DVT device, and SCD device may be used interchangeably without deviating from the teachings provided herein.

The compression therapy device includes or is coupled to a motive source, such as a fluid pump. In an embodiment, the fluid pump may pressurize a fluid, such as, but not limited to, air, nitrogen gas, helium gas, water, or hydraulic oil, for example. The system described herein for activating the user's foot may be used simultaneously with, be integral with, or be removably coupled to a compression therapy device. In one or more embodiments, the system and compression therapy device share a common motive source. In one or more non-limiting embodiments, the system described herein may be used as a stand-alone device.

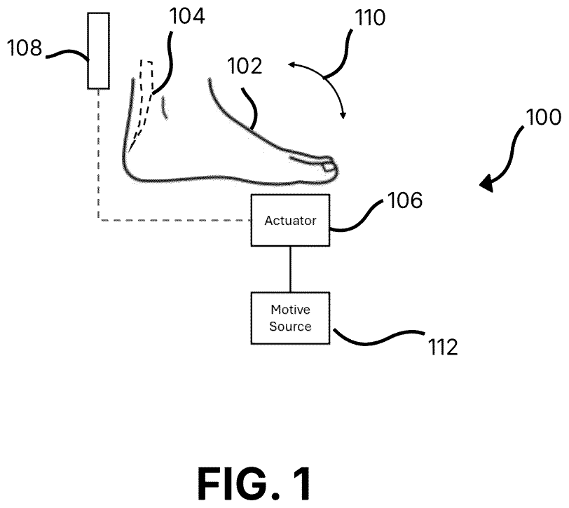

Referring now to FIG. 1, an embodiment of a system 100 is shown for performing therapy on a user's foot and ankle. It should be appreciated that in some circumstances, issues may arise with a user's Achilles tendon, such as when the user is confined to a bed. When this occurs for extended periods of time, reduced ankle motion may be associated with reduced cyclic loading of the Achilles tendon and reduced activation of the lower-leg musculature. In some cases, the reduction in cyclic loading and muscle activation may be associated with decreases in tendon and muscle conditioning.

In some users, prolonged plantarflexed positioning of the foot relative to the lower leg may be associated with adaptive shortening of posterior soft tissues, including the Achilles tendon. Such changes may present as reduced ankle range of motion, including reduced dorsiflexion, when the user later attempts standing or ambulation.

In some users, reduced tendon excursion and reduced muscle-tendon loading may be associated with increases in stiffness of the tendon and/or surrounding soft tissues. These conditions may be associated with discomfort during mobilization, increased susceptibility to strain during physical therapy, or extended time to regain baseline gait mechanics. In some cases, in the absence of consistent and appropriate therapy, the impairment of these muscles and tendons may be short-term, long-term, or permanent.

In an embodiment, the system 100 addresses these issues that may occur with a user's Achilles tendon 104 or other muscles in the foot and ankle. In an embodiment, the system 100 includes an actuator 106. The actuator 106 is arranged to engage the user's foot, such as proximate the toes or ball of the foot 102, for example. The system 100 includes a fixation member 108 that cooperates with the actuator 106 to cause the user's foot 102 to flex and move in the directions indicated by arrow 110 about the ankle joint (i.e., the talocrural joint). In an embodiment, the fixation member 108 is operably coupled to the actuator 106 such that the position of the actuator is positionally fixed relative to the user's lower leg. By causing movement of the foot 102 in this manner, the Achilles tendon 104 and other muscles or tendons in the foot 102 and ankle are actuated, and at least some of the soft tissue issues described above can be alleviated.

In an embodiment, the actuator 106 may be any suitable actuator, such as, but not limited to, pneumatic, hydraulic, electromechanical, shape-memory, magnetic, or mechanical actuators, for example. Pneumatic systems may include, but are not limited to, pneumatic bellows actuators (e.g., bellows 206 described herein); pneumatic bladder actuators; pneumatic rotary vane actuators (pressurized air driving a vane to generate torque about the ankle joint axis); pneumatic cylinders (linear piston-cylinder converting pressure to linear displacement); pneumatic stepper actuators (multi-chamber pneumatic actuators configured for discretized angular or linear steps); and vacuum-actuated bellows or diaphragms (negative pressure driving retraction and/or return motion), for example.

In embodiments where the actuator 106 uses hydraulics, the hydraulic actuator may include, but is not limited to, a hydraulic cylinder actuator (using pressurized liquid driving a piston for linear displacement) and a hydraulic rotary actuator (using pressurized liquid producing rotational output). Electromechanical actuators may include, but are not limited to, lead-screw actuators (a motor-driven screw generating linear displacement); ball-screw actuators (a motor-driven ball screw configured for higher efficiency linear displacement); belt-and-pulley type actuators (motor output translated into linear motion through a belt); gearmotors with crank-slider mechanisms (motor-driven rotary output converted to oscillatory linear displacement); servo motor actuators (closed-loop motors with position control, coupled to linkage or screw); stepper motor actuators (open-loop or closed-loop steppers coupled to linkage or screw); solenoid actuators (electromagnetic plungers providing short-stroke linear displacement); and linear motor actuators (direct-drive electromagnetic linear translation), for example.

Shape memory actuators use a shape-memory alloy (SMA), which changes shape in response to an input, such as a change in temperature. The shape memory actuator may include, but is not limited to, shape-memory alloy actuators (which provide thermally induced contraction/extension of SMA elements); shape-memory polymer actuators (which provide thermally induced shape change producing displacement); electroactive polymer actuators (which use field-driven deformation producing bending or extension); and SMA wire and pulley actuators (SMA contraction routed over pulleys to generate angular foot motion). Magnetic actuators may include, but are not limited to, magnetostrictive actuators (field-driven strain generating displacement); electromagnetic clutch/brake with spring return (selective coupling to generate periodic motion with passive return); and eddy-current actuators (magnetic field interaction producing damping or controlled resistive force).

Mechanical actuators include, but are not limited to, cam-driven actuators (rotary input driving a cam profile to impart a prescribed displacement); four-bar linkage actuators (linkages configured to convert input motion into ankle dorsiflexion and/or plantarflexion); cable-driven (tendon-driven) actuators (motor or pneumatic pull mechanisms applying tension to a strap or cable routed about an ankle); ratchet-and-pawl actuators (incremental motion generation with discrete locking positions); spring-biased actuators (springs providing return force in combination with a powered stroke); and thermal actuators (resistive heating elements producing expansion-driven motion via bimetal or wax motor).

In an embodiment, the actuator 106 may be operably connected to a motive source 112 that is configured to provide the energy used to cause foot deflection. The motive source 112 is configured to provide the medium used by the actuator, such as pressurized air (pneumatic actuator), pressurized fluids (hydraulic actuator), or electrical power (electromechanical, shape-memory, and mechanical actuators). One or both of the actuator 106 and motive source 112 are operably coupled to a controller (not shown) that is configured to control the movement of the user's foot in a predetermined manner. In an embodiment, the controller is configured to cause the actuator 106 to move the user's foot 102 in a predetermined periodic or aperiodic basis. In an embodiment, the controller is configured to cause the actuator 106 to move the user's foot 102 in a predetermined number of times or for a predetermined amount of time. In still further embodiments, the controller is configured to adjust the rate of movement/rotation of the actuator 106 and/or the speed at which the user's foot 102 is moved or rotated.

It should be appreciated that this type of foot/ankle therapy may occur in a hospital, rehabilitation facility, other medical facilities, or patient residences that have specialized beds for patients. These beds are sometimes colloquially referred to as “hospital beds.” These types of beds sometimes have pneumatic pumps integrated into the bed. These pumps may be used to provide pressurized air for patient support surfaces and therapeutic accessories (such as compression therapy devices, for example). For example, such pumps may be used to inflate, deflate, and/or regulate pressure within alternating-pressure or low-air-loss mattress systems to manage interface pressures between the patient and a mattress. In some embodiments, the pumps may include one or more valves and/or manifolds configured to distribute pressurized air to multiple pneumatic circuits and may include venting functionality to allow deflation of one or more pneumatic components.

In an embodiment, the system 100 may be configured to couple with the hospital bed pneumatic pump, which acts as the motive source 112 for the actuator 106. In this embodiment, the system 100 may cooperate with, or be used separately from, other therapeutic accessories. Further, for purposes of clarity, the system 100 may be used in other environments that do not include hospital beds.

It should be appreciated that in the example embodiments provided herein, the motive source 112 may be a pneumatic pump. However, in other embodiments, the motive source 112 may include a hydraulic pump, a heater (for SMA devices), an electric motor, or an electrical power supply.

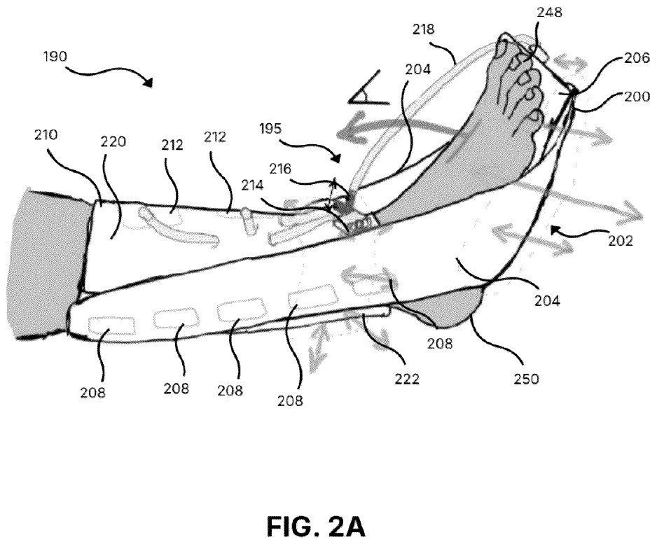

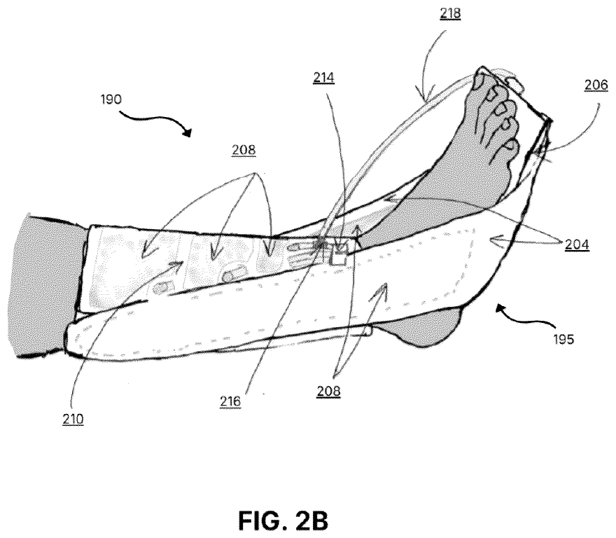

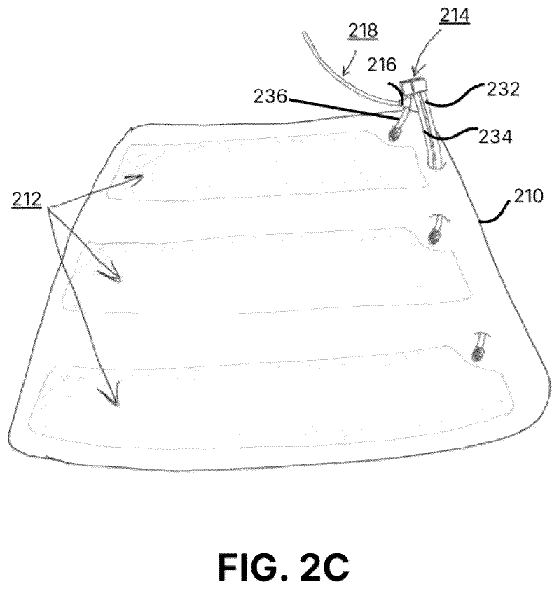

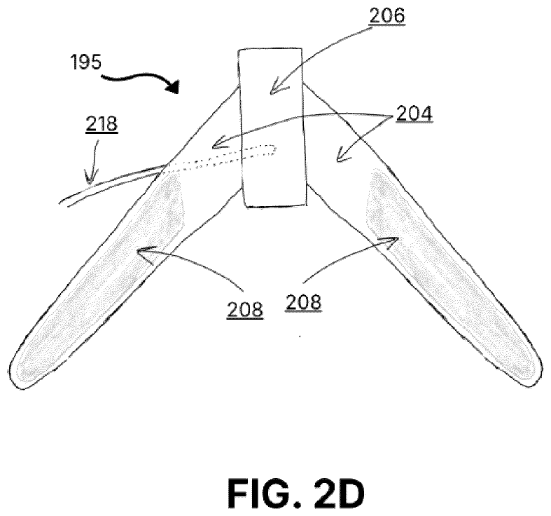

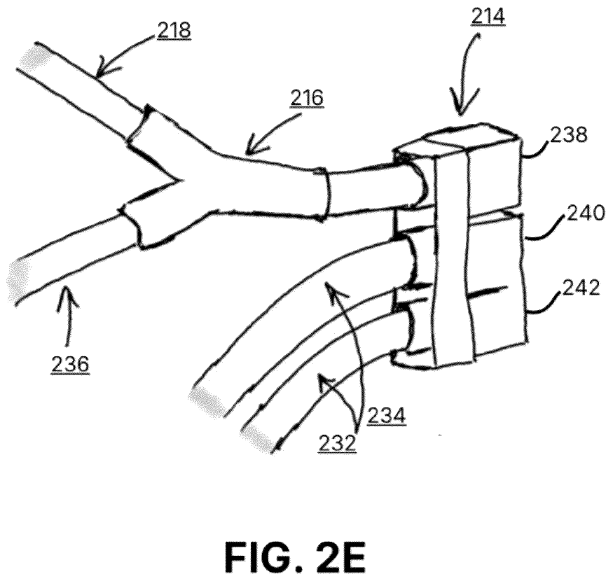

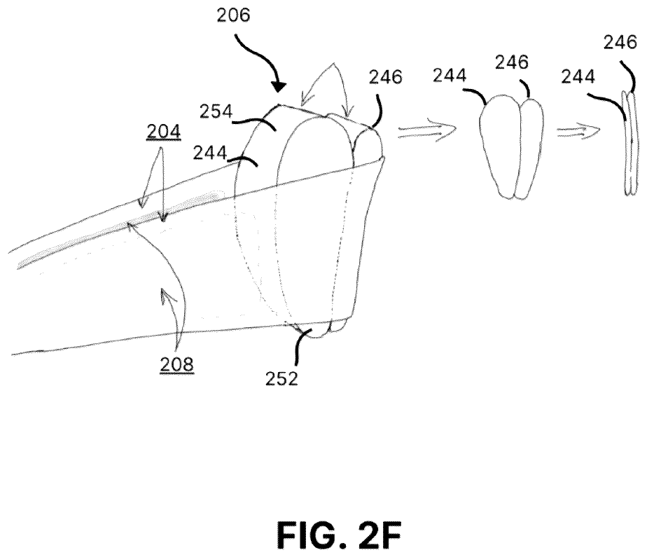

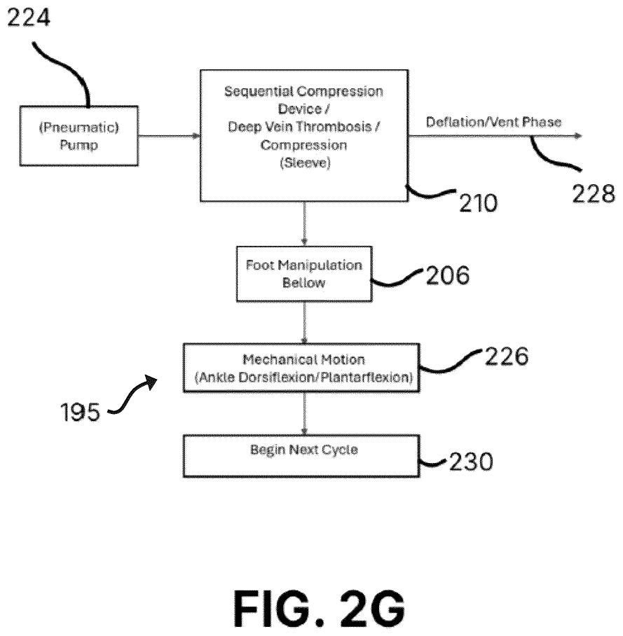

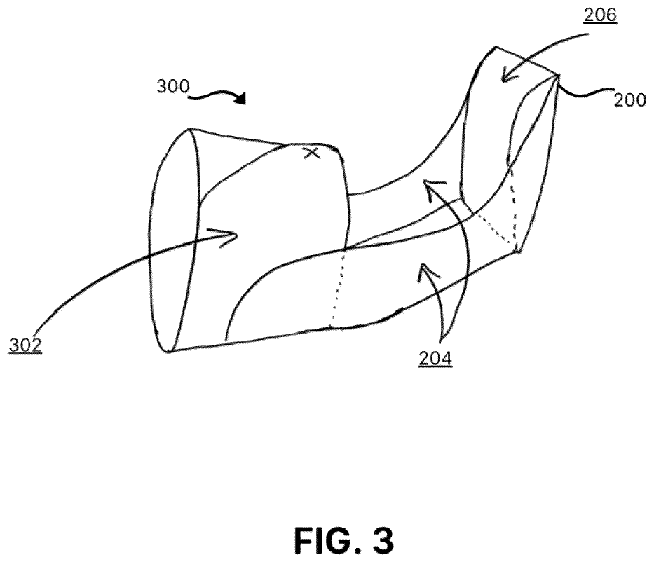

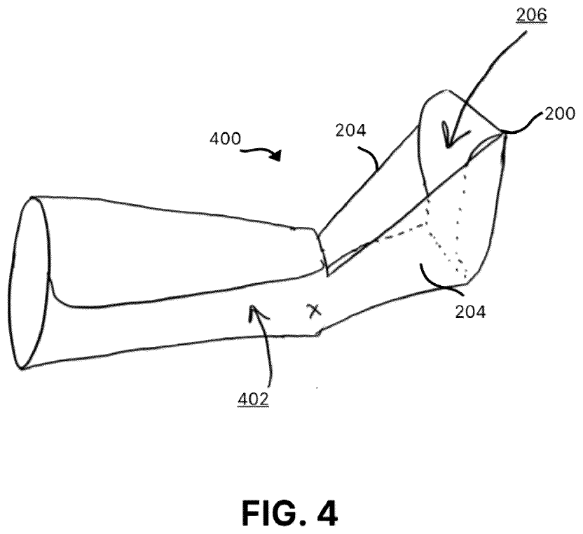

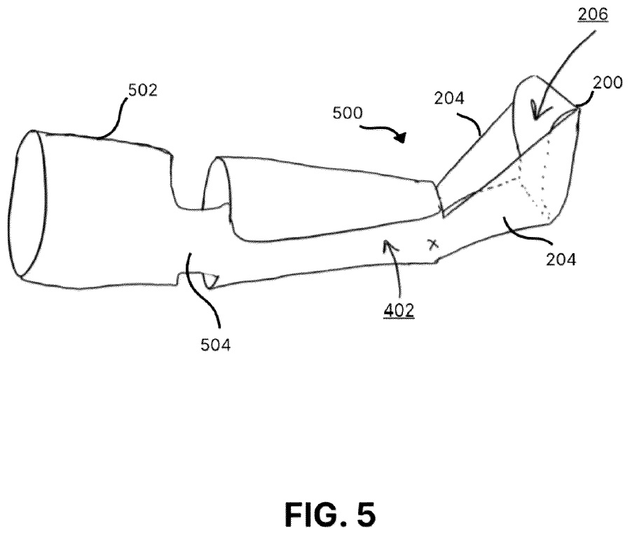

Referring now to FIG. 2A-FIG. 2G, an embodiment of a system 190 is shown for manipulating a user's foot, ankle, and/or lower leg. It should be appreciated that while the embodiment of FIG. 2A-FIG. 2G illustrates a device 195 as cooperating with, or being used in conjunction with, a compression therapy device, this is for example purposes, and the claims should not be so limited. In other embodiments, such as those illustrated with respect to FIG. 3, FIG. 4, and FIG. 5, for example, the system 190 may be used without a compression therapy device.

The system 190 comprises a device 195 and a fixation device, such as a compression therapy device 210, for example. The device 195 includes a body having a foot portion 200 and a connection portion 202. In an embodiment, the connection portion 202 consists of a pair of fastening straps 204 that extend from opposite sides of the foot portion 200. In an embodiment, at least a portion of the fastening straps 204 is adjacent to the user's heel 250.

Coupled to the foot portion 200 is an actuator 206, such as bellows, for example, which is positioned between the foot portion and the bottom of the user's foot. In an embodiment, the bellows 206 is positioned adjacent to the user's toes 150. In another embodiment, as shown in FIG. 2F, the bellows 206 extends along the length of the user's foot. In an embodiment, the bellows 206 is shaped such that a first portion 252 adjacent to the user's heel 250 has a first size when inflated and a second portion 254 adjacent to the user's toes 248 has a second size when inflated. The second size is larger than the first size. In an embodiment, when the bellows 206 is evacuated, deflated, or vented (FIG. 2F), the bellows are substantially flat. The bellows 206 is fluidly coupled to a conduit 218 that provides pressurized air to inflate the bellows as discussed in more detail herein.

It should be appreciated that while embodiments herein illustrate the actuator as being a pneumatically driven bellows, this is for example purposes, and the claims should not be so limited. In other embodiments, other types of actuators may be used, such as those described herein with respect to FIG. 1. For example, the actuator 206 may be a bellows, an inflatable bladder, a wedge-shaped inflation member, an expandable chamber, a pneumatic pad, a hydraulic actuator, or a motor-driven cam or linkage, for example.

In some embodiments, the actuator may be removably connected to the system 190, allowing it to be removed and sterilized, for example. In some embodiments, one or more components of the system 190, such as the actuator, may be intended for single use only or for use with a single patient only and would be disposed of after the treatment or a treatment session is completed. For example, the actuator 206 may be removably or replaceably coupled to the fastening straps 204, allowing the straps to be sterilized and the actuator disposed of, or vice versa.

Devices or components, such as the actuator or the system 190, that are intended to be single use may comply with legal regulations for being a single-use or disposable item. These legal regulations or standards include, but are not limited to: the US Food and Drug Administration (FDA) Single Use Device (“SUD”, 21 CFR regulations) or the International Standards Organization (ISO) standard 13485.These regulations or standards may further include, but are not limited to: ISO 13485:2016 (quality management systems for medical device manufacturers), ISO 10993 series (biological evaluation of medical devices), ISO 15223-1: 2021 (symbols for medical device labeling), ISO 11607 series (packaging for terminally sterilized medical devices), American Society for Testing and Materials (ASTM) F1980 (standard for accelerated aging of sterile barrier systems to support shelf-life determination), International Electrotechnical Commission (IEC) 60601-1 (general safety and performance requirements), IEC 60601-1-2 (electromagnetic compatibility, EMC), ISO 17664-1: 2021 (instructions for cleaning, disinfection, and sterilization), ISO 10993 series including ISO 10993-1 (biocompatibility), ISO 14971 (application of risk management to medical devices), 21 CFR Part 820 (Quality Management System Regulation-QMSR), 21 CFR Part 801 (labeling), 21 CFR Part 807 (registration and listing), or a combination of the foregoing.

It should be further appreciated that some single-use devices may be reprocessed provided it can be established that it was cleaned to a predetermined level. When reprocessed, the systems herein may be cleaned to the Association for the Advancement of Medical Instrumentation (AAMI) TIR30 standard (cleaning validation guidance), including validation of cleaning effectiveness, functional performance, and device life cycle. In still further embodiments, the reprocessing may be performed as defined by Section 510(o) and Section 502(v) of the Food, Drug & Cosmetic (FD&C) Act.

It should be appreciated that while some of the regulations or standards that are identified herein may include a version or a version year, this is for example purposes and the claims should not be so limited. These regulations and standards may be updated from time to time in accordance with applicable regulatory or standards transition periods. Those skilled in the art should appreciate that updated regulations or standards may be utilized without deviating from the teachings provided herein.

In an embodiment, the fastening straps 204 extend from the foot portion 200 along the side of the user's leg (along the lateral aspect and medial aspect), extending towards the user's knee. The fastening strap 204 may include one or more first fastening strips 208 that allow for the fastening strap to be removably coupled to the user's leg. In the embodiment of FIG. 2A, the first fastening strips 208 are hook-and-loop type fasteners that couple with corresponding second fastening strips 212 on an outer surface of the compression therapy device 210. In some embodiments, one of the fastening straps 204 is removably coupled to the compression therapy device 210 or a garment, and the other fastening strap 204 is fixedly coupled to the device.

In the nonlimiting embodiment of FIG. 2A-2G , the compression therapy device 210 includes a plurality of chambers, such as upper chambers 220 and ankle chamber 222. These chambers are inflated on a cyclical, periodic, or aperiodic basis to reduce the risk of blood clots forming in the user's leg. In an embodiment, the compression therapy device 210 further includes a tubing connector 214 that receives pressurized air from a pneumatic pump 126 (FIG. 2G) and distributes the air to the chambers.

In an embodiment shown in FIG. 2E, the connector 214 is a manifold that receives air from a first inlet 238, a second inlet 240, and a third inlet 242. The air received from the third inlet 242 is transferred via an outlet to a first upper chamber conduit 232 and a first upper chamber. The air received from second inlet 240 is transferred via a second upper chamber conduit 234 to a second upper chamber. In an embodiment, the air received from the first inlet 238 is bifurcated by a splitter 216, with a first portion of the air being transferred to conduit 218 to activate the system 100 and a second portion of the air being transferred to the ankle chamber conduit 236.

It should be appreciated that in other embodiments, such as those described with respect to FIG. 3, FIG. 4, and FIG. 5, the conduit 218 may receive pressurized air directly from a pneumatic pump rather than sharing air received from the connector 214.

As discussed herein, the air in conduit 218 is transferred to a bellows 206. In an embodiment shown in FIG. 2F, the bellows 206 is comprised of a first bellows 244 and a second bellows 246. In this embodiment, the second bellows 246 is disposed between the first bellows 244 and the foot portion 200. It should be appreciated that in some embodiments, the second bellows 246 may be omitted and the first bellows 244 is engaged with the foot portion 200.

In an embodiment, the first bellows 244 has a nonuniform shape along a longitudinal direction such that the thickness or height of the bellows at a first portion 252 near the user's heel 250 is smaller than the thickness or height of the bellows at a second portion 254 near the user's toes 248. In some embodiments, the first bellows 244 may have a teardrop shape. In an embodiment, when the system 190 is activated, air flows via conduit 218 to the bellows 206, causing the bellows to move from a deflated or first position to an inflated position. After the bellows 206 is inflated, the system 190 then proceeds to evacuate or vent the air, causing the bellows to deflate. In an embodiment, the system 190 maintains the bellows 206 in an inflated state for a predetermined period of time before evacuating or venting. In an embodiment, when the bellows 206 is in a deflated state, the bellows 206 is substantially flat.

Referring now to FIG. 2G, the operation of the system 190 will be described. In an embodiment, the system 190 is connected to a motive source, such as pneumatic pump 224, that pressurizes air in response to a signal from a controller. The controller may be any suitable digital or analog circuit configured to cause the activation of the pneumatic pump 224 in a predetermined manner. In response to the activation of the pneumatic pump 224, the air flows to the connector 214, which transfers the air to both the compression therapy device 210 and the device 195. The compression therapy device 210 inflates the chambers to compress the wearer's leg or calf to reduce the risk of blood clots or deep vein thrombosis.

In parallel with the operation of the compression therapy device 210, the bellows 206 is inflated to cause foot motion 226 in the user's foot and ankle. In one embodiment, the movement causes ankle dorsiflexion. Ankle dorsiflexion refers to the movement where the foot is flexed upwards towards the shin. This motion is achieved by decreasing the angle between the dorsum of the foot and the anterior aspect of the leg. In an embodiment, the bellows 206 is configured to cause an angle change of 10-15 degrees. Alternatively, or in addition to the ankle dorsiflexion, the bellows 206 may further be configured to cause plantarflexion. Plantarflexion refers to the movement of the foot whereby the toes are moved to increase the angle between the dorsum of the foot and the anterior aspect of the leg.

Once the desired amount of foot motion 226 has been achieved, the system 190 enables or is configured to allow the air to evacuate or vent from the compression therapy device 210 and device 195 to start the next cycle 230.

As discussed herein, the device 195 may be used in cooperation with the compression therapy device 210, separately from the compression therapy device, or integrated into the compression therapy device. Turning now to FIG. 3, an embodiment is shown of a device 300 that is configured to cause motion of a user's foot. The device 300 is similar to the device 195 in that it has a foot portion 200 with a pair of fastening straps 204 extending therefrom. Disposed on the foot portion 200 is an actuator, such as bellows 206, that is configured to selectively move a user's foot. In an embodiment where the actuator is a bellows 206, the actuator is fluidly coupled to a conduit 218 as described herein.

In this embodiment, an ankle/leg anchor 302 is provided that is used to secure the device 300 to the user's leg. In an embodiment, the ankle/leg anchor 302 is integral with the fastening straps 204. In still further embodiments, the ankle/leg anchor 302 is a separate component that is coupled to the fastening straps 204. In an embodiment, the ankle/leg anchor 302 is a generally planar member that is wrapped around the user's leg during use. In an embodiment, the ankle/leg anchor 302 may include fastening elements, such as, but not limited to, hook-and-loop fasteners or clips, for example, which assist in keeping the ankle/leg anchor in place during operation. In an embodiment, the fastening elements may couple with a garment, such as the user's pants.

It should be appreciated that the device 300 may be used in cooperation with a compression therapy device 210, as a standalone device, or as part of a system that integrates the compression therapy device and device 300.

Referring now to FIG. 4, an embodiment is shown of a device 400 that is configured to cause motion of a user's foot. In a similar manner to device 195 and device 300, the device 400 includes a foot portion 200 having a pair of fastening straps 204. An actuator, such as bellows 206, is disposed on the foot portion 200 and is movable between a first position and an expanded position. When the actuator is a bellows 206, the movement of the actuator is in response to air that flows through conduit 218. In this embodiment, the device 400 further includes a compression garment 402 that is configured to engage the user's leg.

A compression garment, as illustrated, comprises a flexible fabric configured to encase a user's limb snugly. This garment may incorporate elastic fibers that provide a uniform pressure distribution across the covered area. Designed with multiple zones, it often features differing levels of compression tailored to specific sections of the limb. Fastening elements, such as hook-and-loop fasteners or zippers, may be integrated to secure the garment in position and facilitate ease of use. The garment may include breathable materials to ensure user comfort during extended wear, and it is sized to accommodate various limb dimensions.

It should be appreciated that while embodiments herein may refer to the member that engages the user's lower leg as being a compression garment, this is for example purposes and the claims should not be so limited. In other embodiments, other types of fixation devices or garments may be used.

In operation, the compression garment 402 holds the device 400 in place relative to the user's leg, allowing the bellows 206 to actuate the user's foot. In an embodiment, the compression garment 402 is integral with the fastening straps 204. In another embodiment, the compression garment 402 is coupled to the fastening straps 204. In still a further embodiment, the compression garment 402 extends from one of the fastening straps 204 and is configured to wrap around the user's leg, with the free edge removably coupled to the fastening straps 204.

Turning now to FIG. 5, another nonlimiting embodiment is shown of a device 500. The device 500 is constructed in a similar manner to device 400 and includes a foot portion 200 with a pair of fastening straps 204 extending therefrom. Like device 400, the device 500 includes a compression garment 402. In this embodiment, a strap 504 extends from an end of the compression garment 402 opposite the foot portion 200. The strap 504 connects the compression garment 402 to a leg anchor 502. In an embodiment, the leg anchor 502 is made from the same or similar material as the compression garment 402. In an embodiment, the leg anchor 502 is configured to fit around a user's thigh, with the strap 504 bridging the user's knee.

In operation, the device 500 operates in the same or similar manner as device 195, device 300, and device 400 to actuate the user's foot.

It should be appreciated that while the embodiment of FIG. 5 describes the device 500 as being used with a compression garment, this is for example purposes and the claims should not be so limited. In other embodiments, the device 500 may be coupled or fixed using other fastening or holding means. For example, the means for holding the foot therapy devices may include elastic straps, adjustable fastening systems, partially permanently affixed components, or other attachment mechanisms. In an embodiment, one of the fastening means may be fixed while another is removable.

It should be appreciated that while some embodiments herein describe or discuss that the system or one or more components thereof are disposable, the point at which the system or portions thereof are discarded may vary depending on the user or the application. In one embodiment, the system or components thereof may be disposed of upon completion of the therapy (e.g., when the user no longer receives or benefits from further therapy). In other embodiments, the system or components thereof may be disposed of based on a soil or cleanliness level. For example, the system or a component thereof may be disposed of when it constitutes a biohazard, a health risk, or is considered unhygienic. In an embodiment, the system or a component thereof may be disposed of at the same time as the compression therapy device sleeve. In another embodiment, the system or components thereof may be disposed of at a predetermined time, such as daily, weekly, or as defined by relevant regulations or standards. In an embodiment, the disposal of the system, a component thereof, or the compression therapy device sleeve may be at a predetermined time, such as defined by Section 201(II) of the FD&C Act, for example.

Embodiments of the present disclosure provide the technical effect of actuating a user's foot to prevent or reduce the risk of muscle or tendon deterioration, such as may be caused by prolonged bed rest, for example. It should be appreciated that while illustrated embodiments show examples of how the user's foot is actuated, these are intended to be nonlimiting examples, and other configurations incorporating a bellows that actuates motion in a user's foot may be achieved without deviating from the teachings provided herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

1. A device for performing compression therapy comprising:
a compression therapy device configured to couple with a user's leg;
a body having a connection portion and a foot portion, the connection portion being configured to couple with the compression therapy device and the foot portion, the connection portion extending from the foot portion;
an actuator disposed on the foot portion and positioned to engage a portion of the user's foot adjacent the user's toes, the actuator configured to move between a first position and an expanded position; and
a motive source operably coupled to the actuator and the compression therapy device, the motive source configured to cause the actuator to move between the first position and the expanded position.

2. The device of claim 1, wherein the actuator is one of a pneumatic, hydraulic, electromechanical, shape-memory, magnetic, or mechanical actuators.

3. The device of claim 2, wherein the actuator is a pneumatic actuator and the motive source is a fluid pump.

4. The device of claim 3, further comprising a conduit having a first end fluidly coupled to the actuator and a second end configured to receive pressurized fluid from the fluid pump.

5. The device of claim 4, wherein the actuator is one of a bellows, a bladder, a wedge-shaped inflatable member or an expandable chamber.

6. The device of claim 4, wherein the second end of the conduit is configured to removably couple with a tubing connector of the compression therapy device.

7. The device of claim 5, wherein the actuator has a first end positioned adjacent the user's heel and a second end adjacent the user's toes, the second end expanding to a size that is larger than the first end when the actuator is in the expanded position.

8. The device of claim 7, wherein the actuator comprises a first actuator and a second actuator, the first actuator being positioned between the second actuator and the foot portion.

9. The device of claim 1, wherein the connection portion includes at least one of a first fastening strap or a second fastening strap arranged on opposite sides of the foot portion adjacent the user's heel.

10. The device of claim 9, further comprising at least one first fastening strip disposed on the first fastening strap and a second fastening strip disposed on the second fastening strap.

11. The device of claim 10, wherein the first fastening strip and the second fastening strip are removably coupled to the compression therapy device.

12. The device of claim 4, further comprising:
a tubing connector having at least one inlet and at least one outlet, at least one of the at least one outlet being fluidly coupled to the second end of the conduit; and
a splitter member having an inlet and at least two outlets, at least one of the two outlets being fluidly coupled to the second end; the other of the at least two outlets being configured to fluidly couple to the compression therapy device.

13. The device of claim 1, wherein the actuator is removably coupled to the body and the motive source.

14. The device of claim 1, wherein at least one of the body and the actuator is a single use device.

15. The device of claim 1, wherein the motive source supplies pressurized fluid to the compression therapy device and the actuator simultaneously.

16. A method for performing therapy, the method comprising:
engaging a compression therapy device with a user's leg;
connecting the compression therapy device with a motive source;
engaging an actuator with a bottom of a user's foot, the actuator being in a fixed position relative to the user's lower leg;
actuating the actuator with the motive source to cause the user's foot to rotate about an ankle joint from a first position to a second position; and
causing the user's foot to rotate from the second position back to the first position.

17. The method of claim 16, further comprising:
receiving pressurized fluid in a conduit;
pressurizing the actuator with the pressurized fluid from the first position to the second position, the actuator being at least partially disposed adjacent the user's toes;
causing a motion of the user's foot from the first position to the second position in response to the actuator being actuated; and
evacuating fluid from the actuator and causing the user's foot to move from the second position to the first position.

18. The method of claim 17, further comprising:
repeating the steps of receiving pressurized fluid, inflating the actuator, causing motion of the user's foot and venting the fluid for a plurality of predetermined cycles; and
wherein the causing of the motion of the user's foot causes at least one of ankle dorsiflexion and plantarflexion of the user's foot.

19. The method of claim 16, further comprising disposing of the actuator upon completion of the therapy or at a predetermined time.

20. A system for performing therapy comprising:
a pump configured to supply pressurized air or fluid;
a compression therapy device configured to be removably coupled to a user's leg, the compression therapy device having at least one chamber that is fluidly coupled to the pump, the therapeutic compression sleeve having at least one first fastening strip disposed on an outer surface;
a fluid connector coupled between the pump and the at least one chamber;
a body having a connection portion configured to couple with the at least one first fastening strip and a foot portion, the connection portion extending from the foot portion;
an actuator disposed on the foot portion and positioned to engage a portion of the user's foot adjacent the user's toes, the actuator configured to move between a first position and an expanded position; and
a motive source operably coupled to the actuator and configured to cause the actuator to move between the first position and second position.
